(19) United States
(12) Patent Application Publication
(10) Pub. No.: US 2010/0153438 A1
(43) Pub. Date: Jun. 17, 2010

(54) METHOD AND APPARATUS FOR SEARCHING FOR HIERARCHICAL STRUCTURE DOCUMENT

(75) Inventors: Tatsuya ASAI, Suwon-si (JP); Shinichiro Tago, Kawasaki (JP); Seishi Okamoto, Kawasaki (JP); Masahiko Nagata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, KAWASAKI (JP)

(21) Appl. No.: 12/634,223

(22) Filed: Dec. 9, 2009

(30) Foreign Application Priority Data
Dec. 11, 2008 (JP) 2008-315923

(51) Int. Cl. G06F 17/30

(52) U.S. Cl. 707/769; 707/E17.014; 707/E17.008

(57) ABSTRACT

A method and apparatus for allowing a computer to search a hierarchical structure document by creating a list in which a true flag indicating that conditions of a predicate of a search formula are satisfied or a false flag indicating that the conditions of the predicate of the search formula are not satisfied is set to a predicate node of the document data based on the search formula, and scanning the list to search for data designated by the search formula from the document data.

### CROSS-REFERENCE TO RELATED APPLICATIONS

This application is based upon and claims the benefit of priority of the prior Japanese Patent Application No. 2008-315923, filed on Dec. 11, 2008, the entire contents of which are incorporated herein by reference.

### FIELD

The present invention relates to a method and apparatus for searching for document data corresponding to a search formula.

### BACKGROUND

In recent years, markup languages, such as XML (extensible markup language), have been used as document data processed by a computer. The XML has been widely used by computers because it enables structured documents and structured data to be easily shared between different information systems, particularly, through the Internet (hereinafter, document data having a hierarchy structure described based on the XML is referred to as “XML data”).

An XPath (XML Path Language) query has been used to detect desired data from the XML data (hereinafter, referred to as a query). The query is a standard query language for the XML data and can describe a search formula for a complicated XML tree structure.

When data is detected from the XML data based on the query, for example, the XML data is scanned to construct a hierarchical list, and a hierarchical list structure is scanned to calculate query implantation. In this way, the position designated by the query in the XML data is specified, and data at the designated position is detected. The following document is included in this technical field: (1) Lu Qin, Jeffrey Xu Yu, and Bolin Ding, 2007, “TwigList: Make Twig Pattern Matching Fast”, DASFAA 2007, p.p. 850-862; (2) Nicolas Bruno, Nick Koudas, and Divesh Srivastava, 2002, “Holistic Twig Joins: Optimal XML Pattern Matching”, ACM SIGMOD 2002, p.p. 310-321.

### SUMMARY

According to an aspect of the invention, a search method of allowing a computer to search for a hierarchical structure document creates a list in which a true flag indicating that conditions of a predicate of the search formula are satisfied or a false flag indicating that the conditions of the predicate of the search formula are not satisfied is set to a predicate node of the document data based on the search formula, and scans the list to search for data designated by the search formula from the document data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the data structure of XML data;

FIG. 2 is a diagram illustrating an example of the tree representation of the XML data;

FIG. 3 is a diagram illustrating data acquired by a query;

FIG. 4 is a diagram illustrating the related art;

FIG. 5 is a diagram illustrating the outline and characteristics of a search apparatus according to an embodiment;

FIG. 6 is a diagram illustrating the effects of the search apparatus according to the embodiment compared with the related art;

FIG. 7 is a functional block diagram illustrating the structure of the search apparatus according to the embodiment;

FIG. 8 is a diagram illustrating an example of the data structure of a path ID table;

FIG. 9 is a diagram illustrating an example of the data structure of BIN data;

FIG. 10 is a diagram illustrating an example of the data structure of an event definition table;

FIG. 11 is a diagram illustrating an example of the data structure of event string data;

FIG. 12 is a diagram illustrating an example of the data structure of a node structure;

FIG. 13 is a diagram illustrating an example of the data structure of event tree data;

FIG. 14 is a diagram illustrating the process of an event string creating unit;

FIG. 15 is a diagram illustrating the process procedure (1) of an event tree creating unit;

FIG. 16 is a diagram illustrating the process procedure (2) of the event tree creating unit;

FIG. 17 is a diagram illustrating the process procedure (3) of the event tree creating unit;

FIG. 18 is a diagram illustrating the process procedure of an event tree scanning unit;

FIG. 19 is a flowchart illustrating the process procedure of the search apparatus according to the embodiment;

FIG. 20 is a flowchart illustrating the process procedure of an event string data creating process;

FIG. 21 is a flowchart illustrating the process procedure of an event tree creating process;

FIG. 22 is a flowchart illustrating a process corresponding to a function parnode(e, T);

FIG. 23 is a flowchart illustrating the process procedure of an event tree scanning process;

FIG. 24 is a flowchart illustrating a process corresponding to a function skipnode(T, v); and

FIG. 25 is a diagram illustrating the hardware structure of a computer forming the search apparatus according to the embodiment.

### DETAILED DESCRIPTION OF EMBODIMENT(S)

In the above-mentioned related art, when the point designated by the query in XML data is specified, in some cases, the scanning of a hierarchical list structure is unnecessarily repeated several times. As a result, the efficiency of calculation is low.

The invention solves the problem of the related art in which the same node is scanned plural times even though the constraints of the query are satisfied, and improves the efficiency of calculation.

Hereinafter, a search method and a search apparatus according to exemplary embodiments of the invention will be described in detail with reference to the accompanying drawings.

### EMBODIMENTS

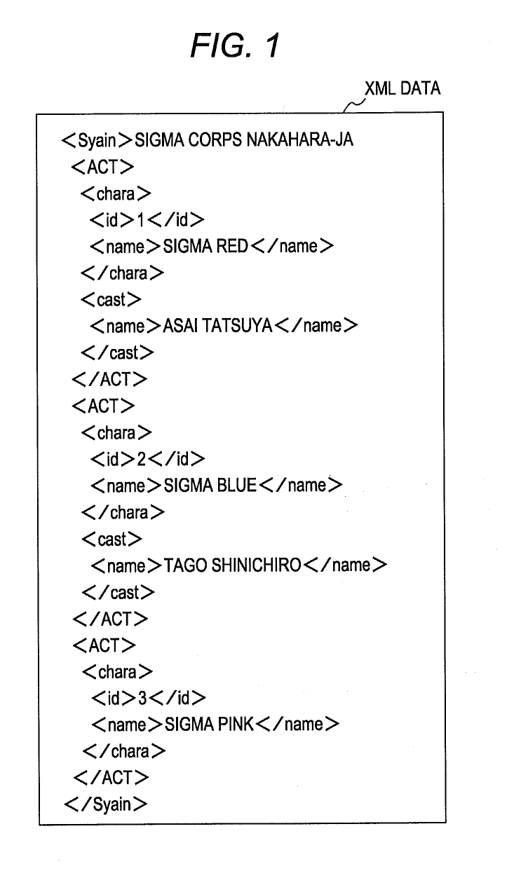

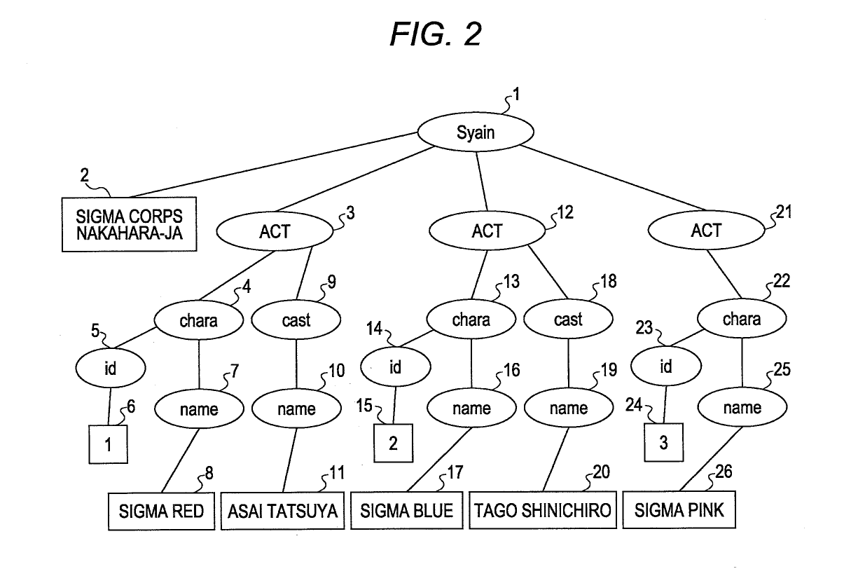

First, XML (extensible markup language) data used in this embodiment will be described. FIG. 1 is a diagram illustrating an example of the data structure of the XML data. As shown in FIG. 1, the XML data has a hierarchical structure in which elements are partitioned by element identifiers “<” and “</”. The XML data shown in FIG. 1 may have a tree structure shown in FIG. 2.

FIG. 2 is a diagram illustrating an example of the tree representation of the XML data. As shown in FIG. 2, in the tree structure of the XML data, the XML data includes element nodes having node IDs 1, 3, 4, 5, 7, 9, 10, 12, 13, 14, 16, 18, 19, 21, 22, 23, and 25, and text nodes having node IDs 2, 6, 8, 11, 15, 17, 20, 24, and 26. The element nodes and the text nodes are connected to each other. For example, Syain1, which is an element node, is connected to a “sigma corps nakahara-ja” 2, which is a text node, and ACTs 3, 12, and 21, which are element nodes.

It is possible to detect data for the check position of a query from the XML data by designating an XPath (XML Path Language) query (hereinafter, referred to as a query). A subset (subset of Xpath 2.0 by W3C) of the query is defined by W3C (world wide web consortium) as follows:

Path::=“/”RPath
RPath::=Step(“/”Step)*
Step::=Axis“::”Ntest(“[”Pred“]”)*
Axis::=“child”
Ntest::=tagname|“*”|“text( )”|“node( )”
Pred::=Expr|Expr“and”Expr|Expr“or”Expr|“not”ExprExpr::RPath|
func“(”RPath“)” (where “tagname” indicates an arbitrary tag name, and
“func” indicates a function that allocates 0 or 1 to each node in the data).

That is, when a set of nodes in the XML data is V, func:V is {0, 1}.

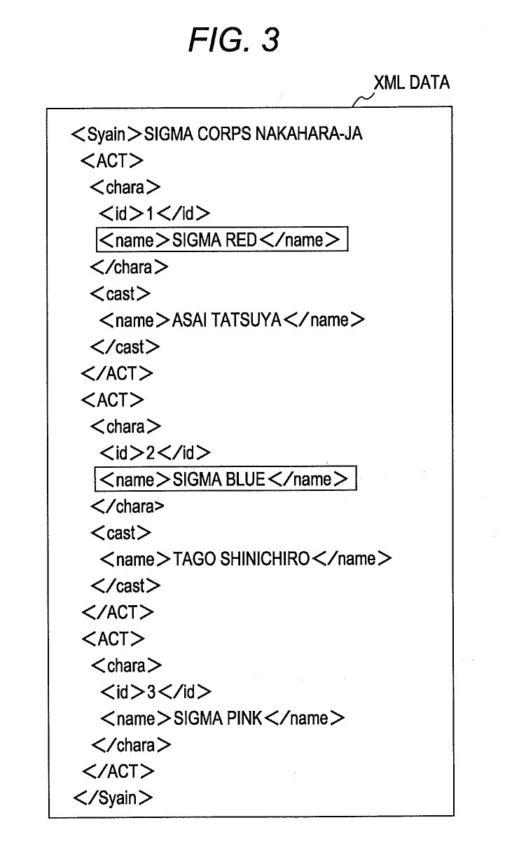

For example, when a query is designated as “Q=/Syain/ACT[cast/name]/chara[id]/name,” name 7 and name 16, which are element nodes, are designated in FIG. 2, data corresponding to the designated points can be obtained. FIG. 3 is a diagram illustrating data obtained by the query. As shown in FIG. 3, “<name>SIGMA RED </name>” and “<name>s SIGMA BLUE</name>” can be obtained from the XML data by the query “Q=/Syain/ACT[cast/name]/chara[id]/name”. In the query, [ ] indicates constraints. For example, ACT[cast/name] indicates that the node “ACT” has the nodes “cast” and “name” as child nodes, and chara[id] indicates that the node “chara” has the node “id” as a child node.

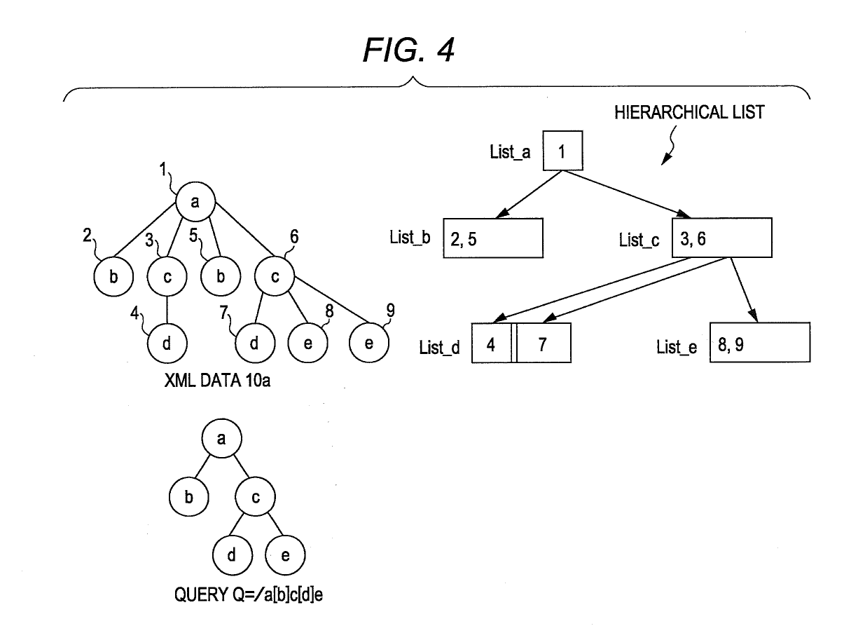

Next, the evaluation of the query according to the related art (TwigList [Qin et, al.; DASFAA'07]) will be described. FIG. 4 is a diagram illustrating the related art. In FIG. 4, for convenience of explanation, the tree structure of XML data 10a is shown on the upper left side of FIG. 4, and a query is “Q=/a[b]c[d]e” (the tree structure of the query is shown on the lower left side of FIG. 4). In addition, the numbers added to the labels a to e of the XML data 10a indicate node IDs.

In the related art, first, the XML data 10a is scanned to construct a hierarchical list for evaluating the query. The hierarchical list of the XML data 10a is shown on the right side of FIG. 4. The hierarchical list includes List_a to List_e corresponding to the labels a to e of the XML data 10a. List_a to the List_e have the node IDs added to the labels of the XML data 10a, and are connected to the XML data 10a so as to correspond thereto.

Specifically List_a has node ID “1”, List_b has node IDs “2, 5”, List_c has node IDs “3, 6”, List_d has node IDs “4, 7” and List_e has node IDs “8, 9”.

The node ID “1” of List_a is connected to the node IDs “2, 5” of List_b and the node IDs “3, 6” of List_c. In addition, the node ID “3” of List_c is connected to the node ID “4” of List_d, and the node ID “6” of List_c is connected to the node ID “4” of List_d and the node IDs “8, 9” of List_e.

Then, in the related art, the hierarchical list is scanned to calculate query implantation. When the implantation of a query “C)=/a[b]c[d]e” is calculated, node ID strings (1, 2, 6, 7, 8), (1, 2, 6, 7, 9), (1, 5, 6, 7, 8), and (1, 5, 6, 7, 9) correspond to the conditions of the query.

The matching point between the node ID strings (1, 2, 6, 7, 8) and (1, 5, 6, 7, 8) is the node ID “8”, and the matching point between the node ID strings (1, 2, 6, 7, 9) and (1, 4, 6, 7, 9) is the node ID “9”. Therefore, the context node obtained by the implantation of the query “Q=/a[b]c[d]e” has the node IDs “8, 9”.

However, in the related art, for example, when a plurality of node IDs is included in the same label as in List_b in the hierarchical list, it is necessary to repeatedly scan the query a number of times corresponding to the number of node IDs included in the List_b. In the hierarchical list, the inclusion of a plurality of node IDs in one list means that there is a plurality of nodes having the same label added thereto in the same brother in the XML data (for example, see the node having the node ID 2 and the node having the node ID 5 in the XML data 10a).

That is, when the hierarchical list is scanned to calculate the implantation of the query “Q=/a[b]c[d]e”, for example, the constraints of the node ID “1” included in List_a (here, the constraints of Q=/a[b]) are satisfied at the time when the node ID “2” included in List_b is referred to. Therefore, it is meaningless to refer to the node ID “5” of List_b again, and the efficiency of calculation is lowered.

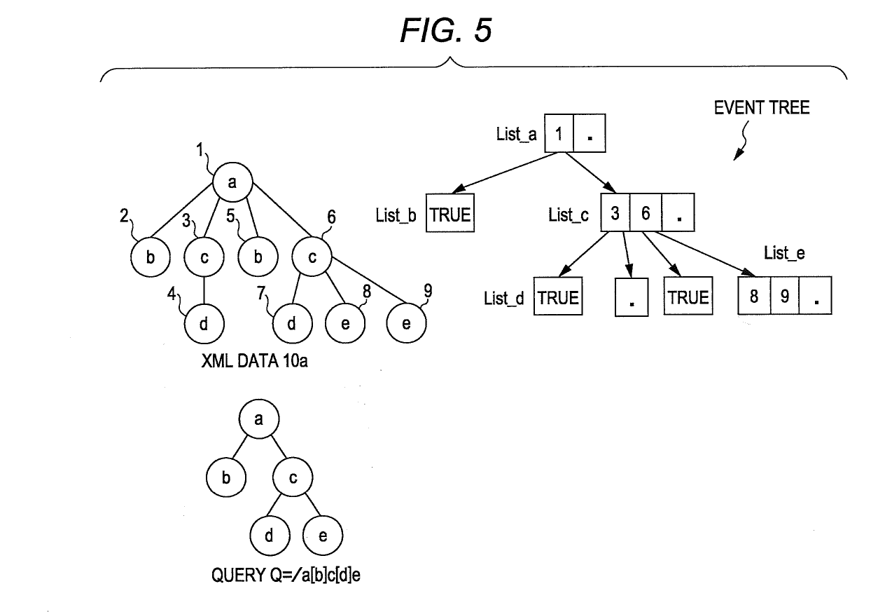

Next, the outline and characteristics of the search apparatus according to this embodiment will be described. FIG. 5 is a diagram illustrating the outline and characteristics of the search apparatus according to this embodiment. In this embodiment, for convenience of explanation, the XML data 10a and the query “Q=/a[b]c[d]e” shown in FIG. 5 are used.

As shown in FIG. 5, the search apparatus according to this embodiment creates an event tree in which a predicate node (a portion for checking whether the constraints are satisfied) of the XML data corresponding to the predicate (constraints) of the query is represented by “true” or “false”, instead of making the hierarchical list of the related art. Therefore, when query implantation is calculated, the efficiency of calculation is improved.

In this case, “true” included in the event tree is a flag indicating that the constraints of the query are satisfied, and “false” is a flag indicating that the constraints of the query are not satisfied. For example, since the node IDs “2, 5” included in List_b shown in FIG. 4 satisfy the constraints of Q=/a[b], List_b connected to the node ID “1” of List_a is bit_b “true”.

In addition, since the node ID “4” included in List_d shown in FIG. 4 satisfies the constraints of Q=/a[b]c[d], List_d connected to the node ID “3” of List_c is bit_d “true”. Since the node ID “7” included in List_d shown in FIG. 4 satisfies the constraints of Q=/a[b]c[d], List_d connected to the node ID “6” of List_c is bit_d “true”. In addition, “.” included in the event tree shown in FIG. 5 indicates the end of the node.

The search apparatus according to this embodiment creates the event tree shown in FIG. 5, scans the event tree, and calculates query implantation. Specifically, a process of using the event tree shown in FIG. 5 to calculate the implantation of the query “Q=/a[b]c[d]e” will be described. First, the search apparatus moves to List_a and refers to bit_b. Since bit_b is “true”, the search apparatus moves to List_c.

The search apparatus refers to bit_d connected to the node ID “3”. As a result, since bit_d is “true” and the node ID “3” is connected to “.” (the node is a terminal node), the search apparatus moves to the node ID “6”.

The search apparatus moves to the node ID “6” and refers to bit_d. Since bit_d is “true”, the search apparatus moves to List_e. Since no node is connected to the node IDs “8, 9” included in List_e, the node IDs “8, 9” are designated by the query “Q=/a[b]c[d]e” (context node).

In the example shown in FIG. 5, all the lists are “true”. However, when bit connected under List is “false”, the scanning of the nodes under List is skipped. For example, when “false” is registered to bit_b shown in FIG. 5, the scanning of the lists below List_a stops.

In this manner, the search apparatus according to this embodiment refers to “true” or “false” of bit connected thereto at once to determine whether List_a to List_e satisfy the constraints, and determines whether to continue or stop the scanning of the lists below List based on the reference result, thereby determining a check position. Therefore, unlike the related art shown in FIG. 4, it is not necessary to repeatedly perform scanning plural times. As a result, it is possible to improve the efficiency of calculation.

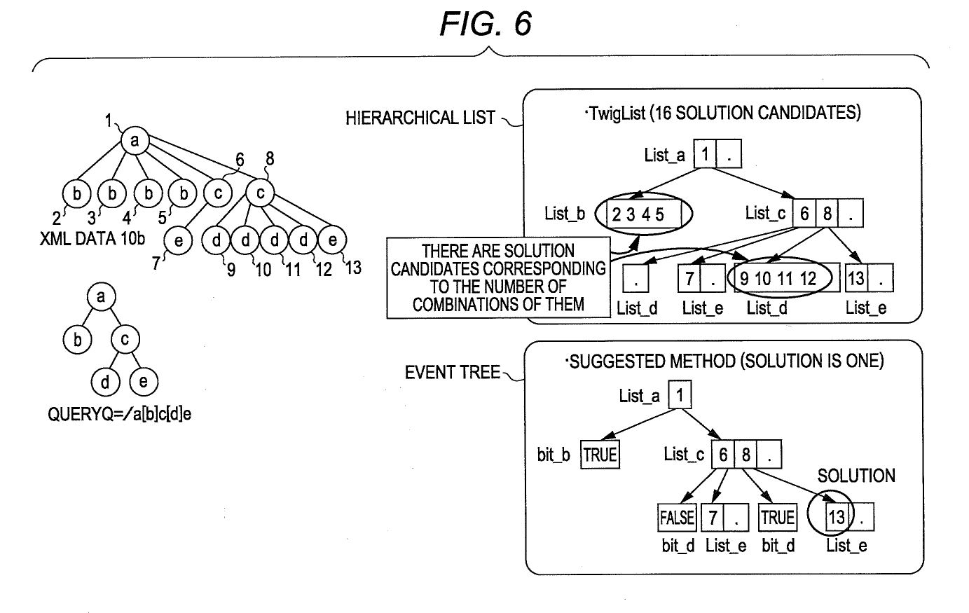

FIG. 6 is a diagram illustrating the effects of the search apparatus according to this embodiment compared with the related art. For convenience of explanation, the XML data 10b has a tree structure shown on the upper left side of the FIG. 6, and a query is represented by “Q=/a[b]c[d]e” (the tree structure of the query is shown on the lower left side of FIG. 6). In addition, the numbers given to the labels a to e of the XML data 10b are node IDs.

The hierarchical list shown on the upper right side of FIG. 6 is constructed by scanning the XML data 10b by the same method as that shown in FIG. 4. The event tree shown on the lower right side of FIG. 6 is created instead of the hierarchical list by the same method as that shown in FIG. 5.

In the hierarchical list shown in FIG. 6, List_b includes a plurality of node IDs “2, 3, 4, and 5” (four node IDs), and List_d includes a plurality of node IDs “9, 10, 11, and 12” (four node IDs). Therefore, 16 scanning operations are needed to obtain the same designated point “node 13” by a combination of List_b and List_d.

In the event tree shown in FIG. 6, since a predicate node (a portion for checking whether to satisfy the constraints) is represented by “true” or “false”, the solution of the query “Q=/a[b]c[d]e” for the XML data 10b is only one. Therefore, it is not necessary to perform a plurality of scanning operations, as in the hierarchical list shown in FIG. 6 by the method shown in FIG. 4.

When the data size of the XML data is n and the query size thereof is q, the amount of calculation is O(q·n^{q}) in the related art. However, the amount of calculation of the search apparatus according to this embodiment is O(q·n). That is, as the query size q is increased, the amount of calculation of the search apparatus according to this embodiment is significantly reduced. In addition, when a large number of nodes with the same label in the XML data appear in the same brothers, combinations of solution candidates are increased in the related art. However, in this embodiment, since the solution of the search apparatus is one, it is possible to improve the efficiency of calculation.

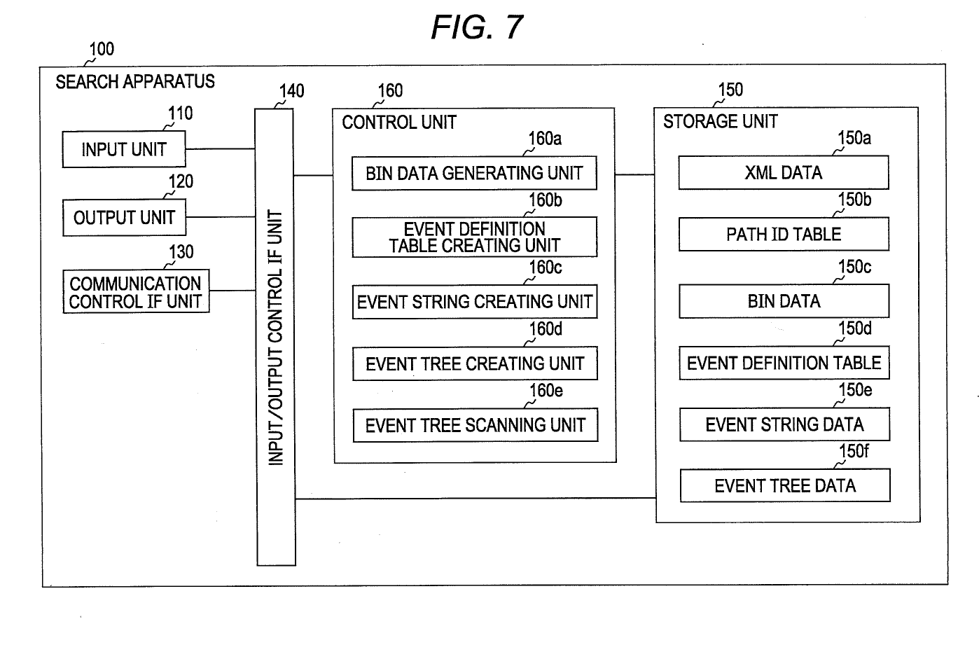

Next, the structure of the search apparatus according to this embodiment will be described. FIG. 7 is a functional block diagram illustrating the structure of the search apparatus according to this embodiment. As shown in FIG. 7, a search apparatus 100 includes an input unit 110, an output unit 120, a communication control IF unit 130, an input/output control IF unit 140, a storage unit 150, and a control unit 160. It is assumed that the search apparatus 100 is connected to a terminal apparatus (not shown) through a network.

The input unit 110 is an input device that inputs various types of information. The input unit 110 is composed of, for example, a keyboard, a mouse, and a microphone, and receives and inputs, for example, various types of information related to the XML data. A monitor (output unit 120), which will be described below, implements a pointing device function in cooperation with the mouse.

The output unit 120 is an output device that outputs various types of information, and is composed of a monitor (or a display or a touch panel) or a speaker. The output unit 120 outputs, for example, various types of information related to the XML data.

The communication control IF unit 130 controls communication with a terminal apparatus (not shown). The input/output control IF unit 140 controls data input and output by the input unit 110, the output unit 120, the communication control IF unit 130, the storage unit 150, and the control unit 160.

The storage unit 150 is a storage device (memory device) that stores data and programs required for the control unit 160 to perform various processes. In particular, the storage unit 150 stores XML data 150a, a path ID table 150b, BIN data 150c, an event definition table 150d, an event string data 150e, and event tree data 150f as components that are closely related to the invention as shown in FIG. 7.

The XML data 150a is document data having a hierarchy structure in which elements are partitioned by, for example, element identifiers “<” and “</” (see FIG. 1), as described above. The path ID table 150b includes data in which a path included in the XML data 150a is associated with a path ID (identification).

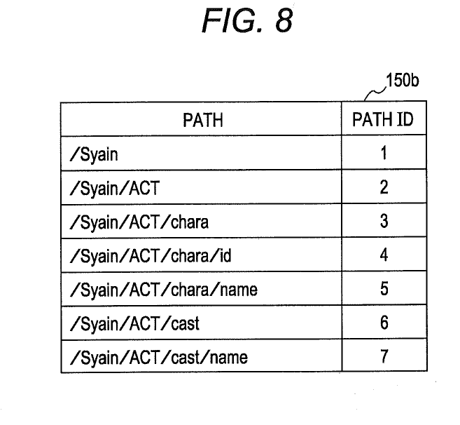

FIG. 8 is a diagram illustrating an example of the data structure of the path ID table. As shown in FIG. 8, in the path ID table 150b, paths are associated with path IDs. For example, a path “/Syain” is associated with a path ID “1”.

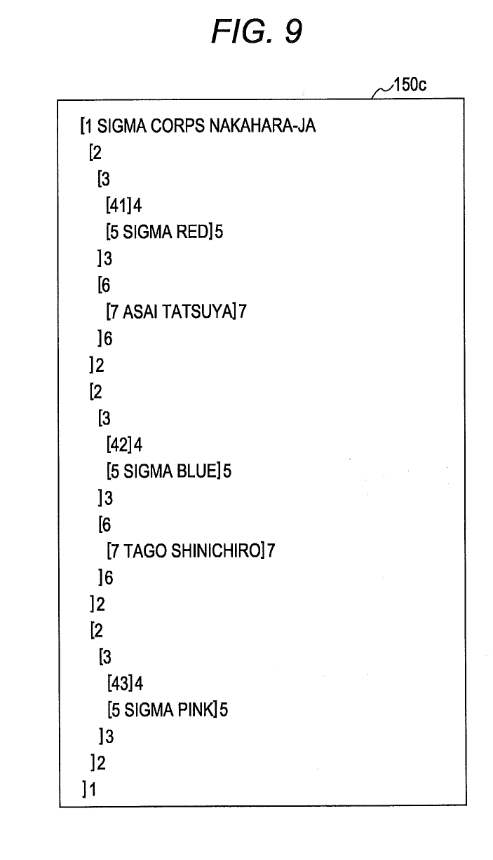

The BIN data 150c is for replacing the elements included in the XML data 150a with the path IDs in the path ID table 150b. FIG. 9 is a diagram illustrating an example of the data structure of BIN data. For example, “<Syain>” of “<Syain> sigma corps nakahara-ja” located at the first stage of the XML data 150a (see FIG. 1) is converted into “[1 SIGMA CORPS NAKAHARA-JA” as shown at the first stage of the BIN data 150c since it corresponds to the path “/Syain” (path ID “1”) in the path ID table (refer to FIG. 8). As described above, it is possible to omit the management of a tag hierarchy in the path check by converting the XML data 150a into the BIN data 150c.

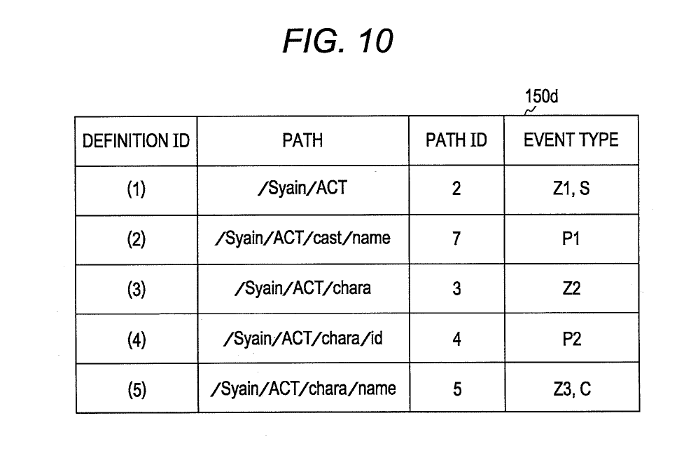

The event definition table 150d includes data in which the type of event included in the query is associated with a path. FIG. 10 is a diagram illustrating an example of the data structure of the event definition table 150d. As shown in FIG. 10, the event definition table 150d includes a definition ID, a path, a path ID, and the type of event such that they are associated with each other. The definition ID is information for identifying a combination of the path, the path ID, and the type of event.

A set ETYPE(Q), which is one type of event, includes path hit events Z1, . . . , Zn, predicate hit events P1, . . . , Pn, a query start event S, and a context node event C. The path hit event indicates that the path is hit, and the predicate hit event indicates that the predicate is hit. In addition, the query start event indicates that a query start path is hit, and the context node event indicates that a query terminal path is hit.

For example, when a query Q=/Syain/ACT[cast/name]/chara[id]/name is designated and an event type set ETYPE(Q)={Z1, P1, Z2, P2, Z3} is designated, the event definition table 150d shown in FIG. 10 is created.

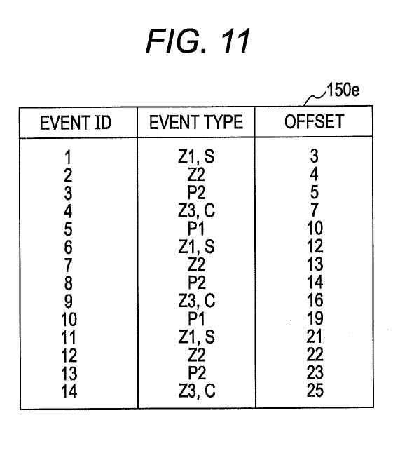

The event string data 150e is generated based on the BIN data 150c and the event definition table 150d, and various types of information of the hit BIN data 150c are stored in the event definition table 150d. FIG. 11 is a diagram illustrating an example of the data structure of the event string data 150e. As shown in FIG. 11, the event string data 150e includes an event ID, the type of event, and an offset such that they are associated with each other. The event ID is information for identifying an event, and the offset indicates the position of data when the event is generated. In the embodiment, for example, the offset is designated by the node ID.

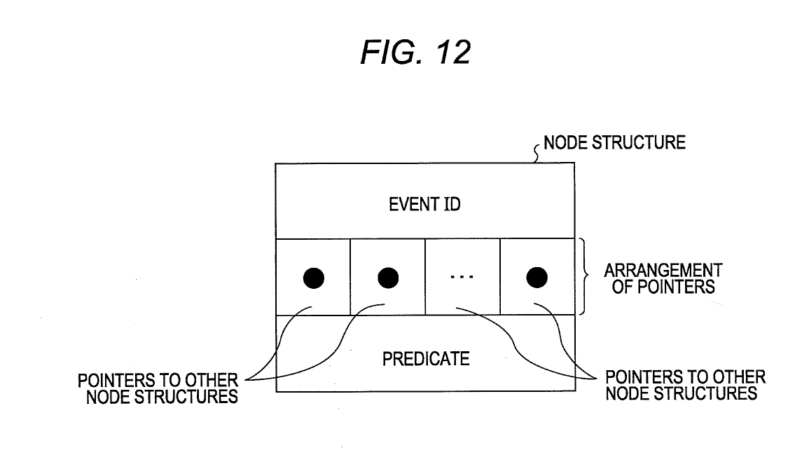

The event tree data 150f is an event tree that is created based on the event string data 150e. The event tree data 150f is constructed by connecting the node structures. FIG. 12 is a diagram illustrating an example of the data structure of the node structure. As shown in FIG. 12, the node structure includes an event ID, pointers to other node structures (the arrangement of pointers), and a predicate. The initial value of the predicate is “false” (Null (−) in the case of a context node), and is changed to “true” according to the query.

When a plurality of pointers is stored in the pointer arrangement, scanning is sequentially performed from the node structure connected to the leftmost pointer.

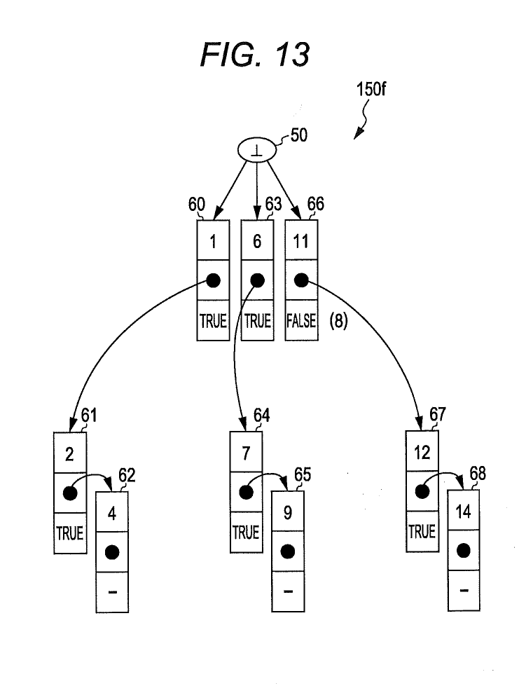

FIG. 13 is a diagram illustrating an example of the data structure of the event tree data 150f. As shown in FIG. 13, the event tree data 150f includes a virtual route 50 and node structures 60 to 68. A method of generating the event tree data 150f shown in FIG. 13 will be described when the event tree creating unit 160d (which will be described below) is described.

The control unit 160 includes an internal memory for storing control data and programs that prescribe various process procedures, and executes various processes using the programs and the control data. The control unit 160 includes a BIN data generating unit 160a, an event definition table creating unit 160b, an event string creating unit 160c, an event tree creating unit 160d, and an event tree scanning unit 160e as components particularly closely related to the present invention, as shown in FIG. 7.

Among them, the BIN data generating unit 160a compares the XML data 150a with the path ID table 150b and replaces the elements included in the XML data 150a with the path IDs, thereby generating the BIN data 150c.

For example, the BIN data generating unit 160a arranges “[1 SIGMA CORPS NAKAHARA-JA” at the first stage of the BIN data 150c in FIG. 1, since “<Syain>” of “<Syain> SIGMA CORPS NAKAHARA-JA” located at the first stage of the XML data 150a corresponds to the path “/Syain” (the path ID “1”) of the path ID table 150b. The BIN data generating unit 160a similarly generates the BIN data 150c at the other stages by comparing the XML data with the path ID table 150b and replacing the elements with the path IDs.

The event definition table creating unit 160b is a processing unit that creates an event definition table corresponding to a query, when the query is acquired. For example, when a query Q=/Syain/ACT[cast/name]/chara[id]/name is designated and an event type set ETYPE(Q)={Z1, P1, Z2, P2, Z3} is designated, the event definition table creating unit 160b makes each path of the query correspond to the event type set to create the event definition table 150d shown in FIG. 10.

In the above-mentioned conditions, a path “/Syain/ACT” corresponds to an event type “Z1”, a path “/Syain/ACT/cast/name” corresponds to an event type “P1”, and a path “/Syain/ACT/chara” corresponds to an event type “Z2”. In addition, a path “/Syain/ACT/chara/id” corresponds to an event type “P2” and a path “/Syain/ACT/chara/id/name” corresponds to an event type “Z3”. A path “/Syain/ACT” is the start path of the query, and allows “S” to be included in the event type. A path “/Syain/ACT/chara/id/name” is the end path of the query, and allows “C” to be included in the event type.

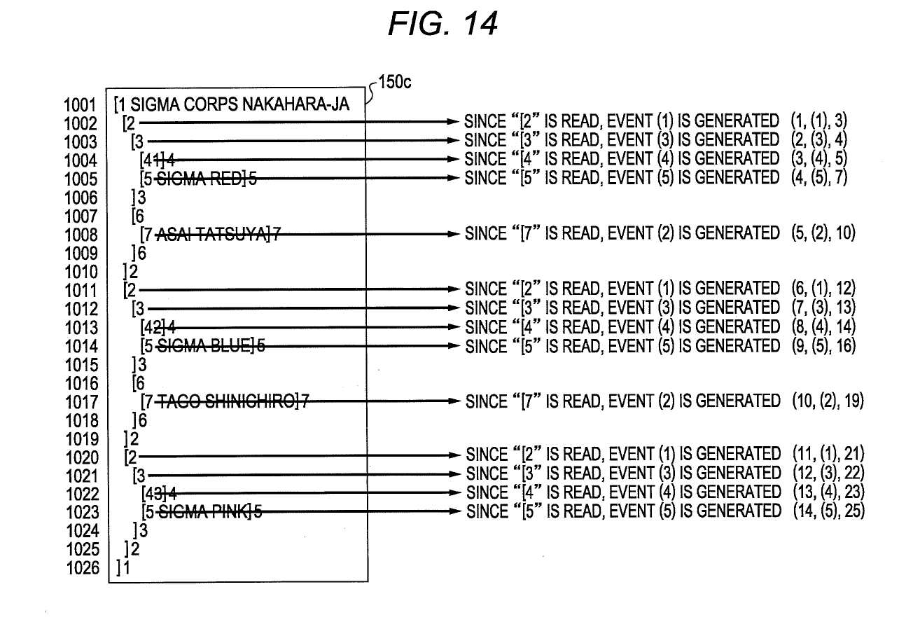

The event string creating unit 160c is a processing unit that creates the event string data 150e based on the BIN data 150c and the event definition table 150d. FIG. 14 is a diagram illustrating the process of the event string creating unit 160c. As shown in FIG. 14, the event string creating unit 160c scans the BIN data 150c character by character and adds 1 to the offset whenever a tag start symbol “[” is detected. In this embodiment, for convenience of explanation, the node ID (see FIG. 2) of the node when an event is generated is used as the value of the offset.

When detecting the path ID included in the event definition table 150d from the rear side of (immediately after) the tag start symbol “[”, the event string creating unit 160c adds 1 to the event ID, and registers the current event ID, the event type, and the offset to the event string. Next, the process of the event string creating unit 160c will be described with reference to FIG. 14.

First, at the position “1001” of the BIN data 150c, no path ID included in the event definition table 150d is detected immediately after the tag start symbol “[”. At the position “1002” of the BIN data 150c, since the path ID “2” included in the event definition table 150d is detected immediately after the tag start symbol “[”, an event (1) is generated, and the event string creating unit 160c registers the event ID “1”, the event types “Z1, 8”, and an offset “3” (corresponding to ACT of the node ID “3” in FIG. 2) to the event string data 150e (see the first stage of FIG. 11). The event (1) indicates an event corresponding to the definition ID (1) of the event definition table 150d. This is similarly applied to the other events (n).

At the position “1003” of the BIN data 150c, the path ID “3” included in the event definition table 150d is detected immediately after the tag start symbol “[”. Therefore, an event (3) is generated, and the event string creating unit 160c registers an event ID “2”, an event type “Z2”, and an offset “4” (corresponding to chara of the node ID “4” in FIG. 2) to the event string data 150e (see the second stage of FIG. 11).

At the position “1004” of the BIN data 150c, the path ID “4” included in the event definition table 150d is detected immediately after the tag start symbol “[”. Therefore, an event (4) is generated, and the event string creating unit 160c registers an event ID “3”, an event type “P2”, and an offset “5” (corresponding to id of the node ID “5” in FIG. 2) to the event string data 150e (see the third stage of FIG. 11).

At the position “1005” of the BIN data 150c, the path ID “5” included in the event definition table 150d is detected immediately after the tag start symbol “[”. Therefore, an event (5) is generated, and the event string creating unit 160c registers an event ID “4”, event types “Z3, C”, and an offset “7” (corresponding to id of the node ID “7” in FIG. 2) to the event string data 150e (see the fourth stage of FIG. 11).

At the position “1006” of the BIN data 150c, the path ID included in the event definition table 150d is not detected immediately after the tag start symbol “[”. At the position “1007” of the BIN data 150c, the path ID included in the event definition table 150d is not detected immediately after the tag start symbol “[”.

At the position “1008” of the BIN data 150c, the path ID “7” included in the event definition table 150d is detected immediately after the tag start symbol T. Therefore, an event (2) is generated, and the event string creating unit 160c registers an event ID “5”, an event type “P1”, and an offset “10” (corresponding to name of the node ID “10” in FIG. 2) to the event string data 150e (see the fifth stage of FIG. 11).

At the position “1009” of the BIN data 150c, the path ID included in the event definition table 150d is not detected immediately after the tag start symbol “[”. At the position “1010” of the BIN data 150c, the path ID included in the event definition table 150d is not detected immediately after the tag start symbol “[”.

At the position “1011” of the BIN data 150c, the path ID “2” included in the event definition table 150d is detected immediately after the tag start symbol “[”. Therefore, the event (1) is generated, and the event string creating unit 160c registers an event ID “6”, event types “Z1, S”, and an offset “12” (corresponding to ACT of the node ID “12” in FIG. 2) to the event string data 150e (see the sixth stage of FIG. 11).

At the position “1012” of the BIN data 150c, the path ID “3” included in the event definition table 150d is detected immediately after the tag start symbol “[”. Therefore, the event (3) is generated, and the event string creating unit 160c registers an event ID “7”, the event type “Z2”, and an offset “13” (corresponding to chara of the node ID “13” in FIG. 2) to the event string data 150e (see the seventh stage of FIG. 11).

At the position “1013” of the BIN data 150c, the path ID “4” included in the event definition table 150d is detected immediately after the tag start symbol T. Therefore, the event (4) is generated, and the event string creating unit 160c registers an event ID “8”, the event type “P2”, and an offset “14” (corresponding to id of the node ID “14” in FIG. 2) to the event string data 150e (see the eighth stage of FIG. 11).

At the position “1014” of the BIN data 150c, the path ID “5” included in the event definition table 150d is detected immediately after the tag start symbol “[”. Therefore, the event (5) is generated, and the event string creating unit 160c registers an event ID “9”, the event types “Z3, C”, and an offset “16” (corresponding to name of the node ID “16” in FIG. 2) to the event string data 150e (see the ninth stage of FIG. 11).

At the position “1015” of the BIN data 150c, the path ID included in the event definition table 150d is not detected immediately after the tag start symbol “[”. At the position “1016” of the BIN data 150c, the path ID included in the event definition table 150d is not detected immediately after the tag start symbol “[”.

At the position “1017” of the BIN data 150c, the path ID “7” included in the event definition table 150d is detected immediately after the tag start symbol “[”. Therefore, the event (2) is generated, and the event string creating unit 160c registers an event ID “10”, the event type “P1”, and an offset “19” (corresponding to name of the node ID “19” in FIG. 2) to the event string data 150e (see the tenth stage of FIG. 11).

At the position “1018” of the BIN data 150c, the path ID included in the event definition table 150d is not detected immediately after the tag start symbol “[”. At the position “1019” of the BIN data 150c, the path ID included in the event definition table 150d is not detected immediately after the tag start symbol “[”.

At the position “1020” of the BIN data 150c, the path ID “2” included in the event definition table 150d is detected immediately after the tag start symbol “[”. Therefore, the event (1) is generated, and the event string creating unit 160c registers an event ID “11”, the event types “Z1, S”, and an offset “21” (corresponding to ACT of the node ID “21” in FIG. 2) to the event string data 150e (see the eleventh stage of FIG. 11).

At the position “1021” of the BIN data 150c, the path ID “3” included in the event definition table 150d is detected immediately after the tag start symbol “[”. Therefore, the event (3) is generated, and the event string creating unit 160c registers an event ID “12”, the event type “Z2”, and an offset “22” (corresponding to chara of the node ID “22” in FIG. 2) to the event string data 150e (see the twelfth stage of FIG. 11).

At the position “1022” of the BIN data 150c, the path ID “4” included in the event definition table 150d is detected immediately after the tag start symbol “[”. Therefore, the event (4) is generated, and the event string creating unit 160c registers an event ID “13”, the event type “P2”, and an offset “23” (corresponding to id of the node ID “23” in FIG. 2) to the event string data 150e (see the thirteenth stage of FIG. 11).

At the position “1023” of the BIN data 150c, the path ID “5” included in the event definition table 150d is detected immediately after the tag start symbol “[”. Therefore, the event (5) is generated, and the event string creating unit 160c registers an event ID “14”, the event types “Z3, C”, and an offset “25” (corresponding to name of the node ID “25” in FIG. 2) to the event string data 150e (see the fourteenth stage of FIG. 11).

At the positions “1024” to “1026” of the BIN data 150c, the path ID included in the event definition table 150d is not detected immediately after the tag start symbol “[”. In this manner, the event string creating unit 160c compares the positions “1001” to “1026” of the BIN data 150c with the event definition table 150d to generate the event string data 150e.

The event tree creating unit 160d is a processing unit that generates the event tree data 150f (see FIG. 13) based on the event string data 150e (see FIG. 11). The event tree creating unit 160d sequentially refers to the event string data 150e according to the event IDs, and creates a node structure when the type of event is a path hit event (Zn; n is a natural number). In addition, when the type of event is a predicate hit event, the event tree creating unit 160d sets the predicate of a node structure to be processed to “true”. Next, the process of the event tree creating unit 160d will be described with reference to detailed examples.

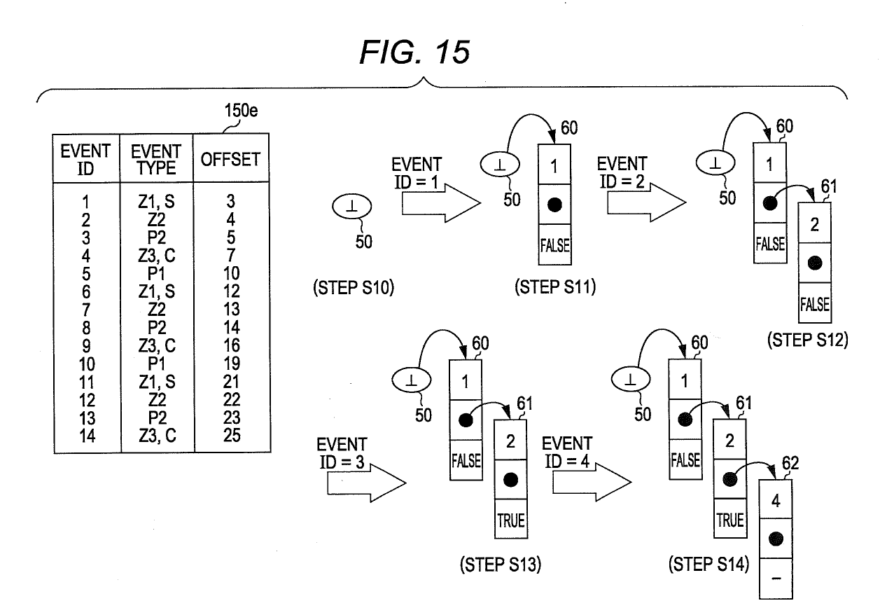

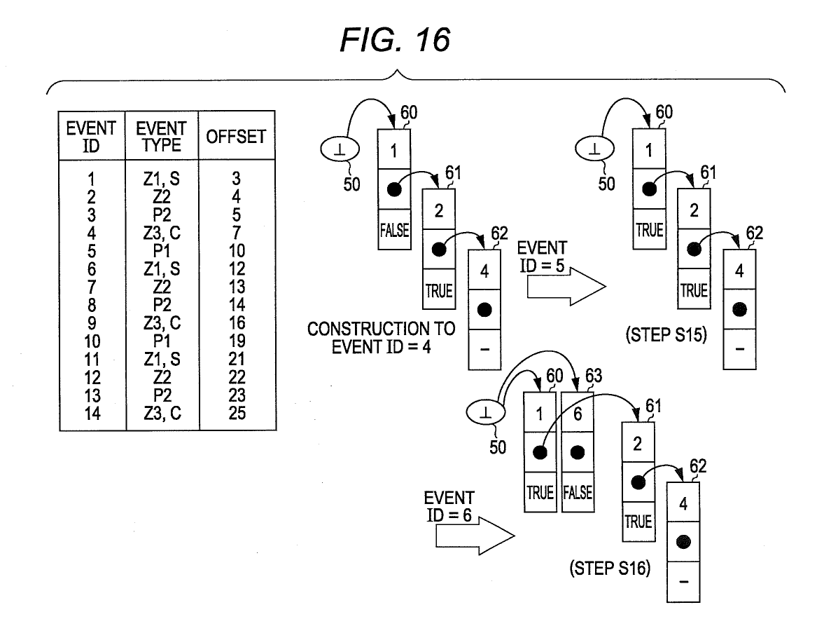

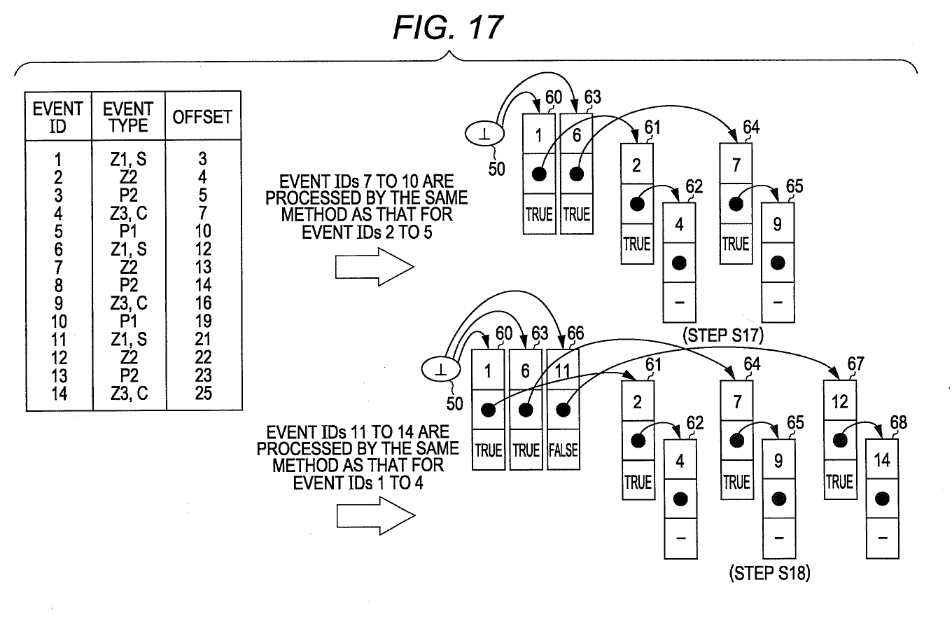

FIGS. 15 to 17 are diagrams illustrating the process procedure of the event tree creating unit 160d. In particular, FIG. 15 is a diagram illustrating the process procedure (1) of an event tree creating unit; FIG. 16 is a diagram illustrating the process procedure (2) of the event tree creating unit; and FIG. 17 is a diagram illustrating the process procedure (3) of the event tree creating unit. First, the event tree creating unit 160d sets an initial tree (virtual route) 50 (Step S10), and refers to the event ID “1” of the event string data 150e. Since the event type of the event ID “1” is a path hit event “Z1”, the event tree creating unit 160d creates a node structure 60. At that time, the event ID of the node structure 60 is “1”, a pointer (a pointer to another node structure) is blank, and the initial value of the predicate is “false”. In addition, the event tree creating unit 160d connects the node structures 60 under the initial tree 50 (Step S11).

The event tree creating unit 160d refers to the event ID “2” of the event string data 150e. Since the event type of the event ID “2” is a path hit event “Z2”, the event tree creating unit 160d creates a node structure 61, and sets the pointer of the node structure 60 to the node structure 61 (Step S12). At that time, the event ID of the node structure 61 is “2”, the pointer is blank, and the initial value of the predicate is “false”.

The event tree creating unit 160d refers to the event ID “3” of the event string data 150e. Since the event type of the event ID “3” is a predicate hit event “P2”, the event tree creating unit 160d sets the predicate of the node structure 61 to “true” (Step S13).

The event tree creating unit 160d refers to the event ID “4” of the event string data 150e. Since the event type of the event ID “4” is a path hit event “Z3”, the event tree creating unit 160d creates a node structure 62, and sets the pointer of the node structure 61 to the node structure 62 (Step S14). At that time, the event ID of the node structure 62 is “4”, the pointer is blank, and the predicate is set to Null (since C<context node> is included in the event type). Then, the event tree creating unit 160d moves to the node structure 60 corresponding to a parent node.

The event tree creating unit 160d refers to the event ID “5” of the event string data 150e. Since the event type of the event ID “5” is a predicate hit event “P1”, the event tree creating unit 160d changes the predicate of the node structure 60 from false to true (Step S15). In addition, the event tree creating unit 160d moves to the initial tree corresponding to a parent node.

The event tree creating unit 160d refers to the event ID “6” of the event string data 150e. Since the event type of the event ID “6” is a path hit event “Z1”, the event tree creating unit 160d creates a node structure 63. At that time, the event ID of the node structure 63 is “6”, the pointer is blank, and the initial value of the predicate is “false”. In addition, the event tree creating unit 160d connects the node structures 63 under the initial tree 50 (Step S16).

The event tree creating unit 160d processes the event IDs “7 to 10” of the event string data 150e using the same method as that for the event IDs “2 to 5”, thereby creating the event tree shown in Step S17. As shown on the upper side of FIG. 17, the node structures 60 and 63 are connected under the initial tree 50, the node structure 61 is connected under the node structure 60, and the node structure 62 is connected under the node structure 61. The node structure 64 is connected under the node structure 63, and the node structure 65 is connected under the node structure 64. In addition, the predicates of the node structures 60, 61, 63, and 64 are “true”, and the predicates of the node structures 62 and 65 are “Null”.

The event tree creating unit 160d processes the event IDs “11 to 14” of the event string data 150e using the same method as that for the event IDs “1 to 4”, thereby creating the event tree shown in Step S18. As shown on the lower side of FIG. 17, the node structures 60, 63, and 66 are connected under the initial tree 50, the node structure 61 is connected under the node structure 60, and the node structure 62 is connected under the node structure 61.

The node structure 64 is connected under the node structure 63, and the node structure 65 is connected under the node structure 64. The node structure 67 is connected under the node structure 66, and the node structure 68 is connected under the node structure 67. In addition, the predicates of the node structures 60, 61, 63, 64, and 67 are “true”, the predicate of the node structure 66 is “false”, and the predicates of the node structures 62, 65, and 68 are “Null”. The event tree creating unit 160d stores the created event tree as the event tree data 150f in the storage unit 150.

As such, the event tree creating unit 160d sequentially refers to the event string data 150e (for example, see FIG. 11) to create the node structures corresponding to the event type, connects the node structures, and sets the predicates of the node structures (the setting of true or false), thereby creating the event tree data 150f (for example, see FIG. 13).

Returning to FIG. 7, the event tree scanning unit 160e is a processing unit that determines the position designated by the query in the XML data 150a based on the event tree data 150f and outputs data corresponding to the determined designation position. The event tree scanning unit 160e determines whether the predicate is set to true with reference to the predicate of the node structure of the event tree data 150f and moves to the subordinate event structure to specify the context node (the position designated by the query).

Specifically, the event tree scanning unit 160e refers to the predicate of the node structure. When the predicate is “true”, the event tree scanning unit 160e moves to the subordinate node structure. On the other hand, when the predicate is “false”, the event tree scanning unit 160e stops the search operation. When the predicate of the node structure is “Null”, the event tree scanning unit 160e determines a node ID corresponding to the node ID of the node structure to be the position (context node) designated by the query.

The event tree scanning unit 160e registers the node ID of a node structure corresponding to the context node to the set R whenever determining the context node. For example, in FIG. 13, when the node structures 62 and 65 correspond to the context nodes, the set R={4, 9} is obtained after scanning.

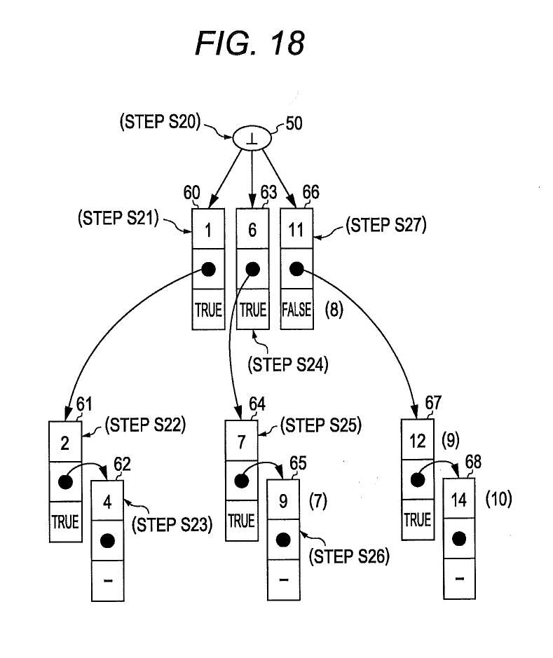

FIG. 18 is a diagram illustrating the process procedure of the event tree scanning unit 160e. As shown in FIG. 18, the event tree scanning unit 160e sets an initial scanning position to a virtual route (route node) 50 (Step S20).

The event tree scanning unit 160e moves the scanning position to the node structure 60. Since the node structure 60 is not a context node and the predicate thereof is “true”, the event tree scanning unit 160e moves the scanning position to the node structure 61 that is connected under the node structure 60 (Step S21).

Since the node structure 61 is not a context node and the predicate thereof is “true”, the event tree scanning unit 160e moves the scanning position to the node structure 62 that is connected under the node structure 61 (Step S22). Since the node structure 62 is a context node and the predicate thereof is “Null”, the event tree scanning unit 160e adds the node ID “4” to the set R, and returns to the virtual route 50 (Step S23).

The event tree scanning unit 160e moves the scanning position to the node structure 63. Since the node structure 63 is not a context node and the predicate thereof is “true”, the event tree scanning unit 160e moves the scanning position to the node structure 64 that is connected under the node structure 63 (Step S24).

Since the node structure 64 is not a context node and the predicate thereof is “true”, the event tree scanning unit 160e moves the scanning position to the node structure 65 that is connected under the node structure 64 (Step S25). Since the node structure 65 is a context node and the predicate thereof is “Null”, the event tree scanning unit 160e adds the node ID “9” to the set R, and returns to the virtual route 50 (Step S26).

The event tree scanning unit 160e moves the scanning position to the node structure 66. Since the node structure 66 is not a context node and the predicate thereof is “false”, the event tree scanning unit 160e searches the node structures that have not been scanned among the node structures connected to the virtual route 50. However, when all the node structures are completely scanned, the event tree scanning unit 160e ends the process (Step S27).

The event tree scanning unit 160e ends the scanning operation for the event tree data 150f, extracts data corresponding to the position designated by the query based on the node IDs stored in the set R, and outputs the extracted data.

For example, when the node IDs “4, 9” are stored in the set R, the node IDs 7 and 16 correspond to the event IDs 4 and 9 (see FIG. 11). Therefore, “name” of the node ID 7 and “name” of the node ID 16 are designated by the query. The event tree scanning unit 160e outputs data “<name>sigma red<name>” corresponding to “name” of the node ID 7 and data “<name>sigma blue<name>” corresponding to “name” of the node ID 16 (for example, see FIG. 3).

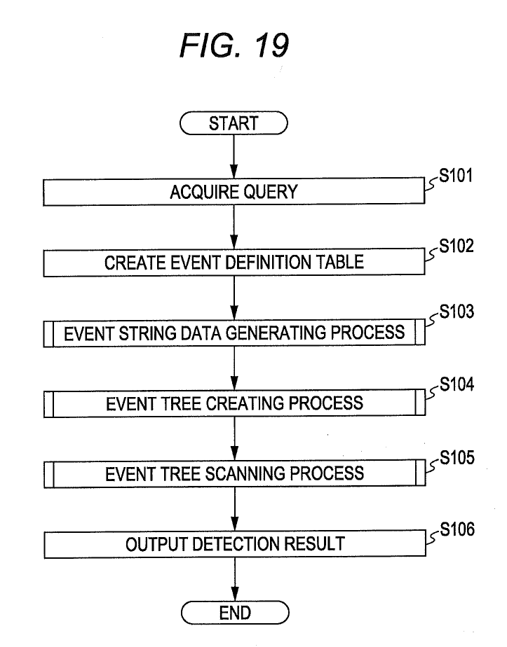

Next, the process procedure of the search apparatus 100 according to this embodiment will be described. FIG. 19 is a flowchart illustrating the process procedure of the search apparatus 100 according to this embodiment. As shown in FIG. 19, the search apparatus 100 acquires a query (Step S101), and the event definition table creating unit 160b creates the event definition table 150d (Step S102).

Then, the event string creating unit 160c performs an event string data creating process (Step S103), and the event tree creating unit 160d performs an event tree creating process (Step S104).

Then, the event tree scanning unit 160e performs an event tree scanning process (Step S105), and outputs the detection result (Step S106).

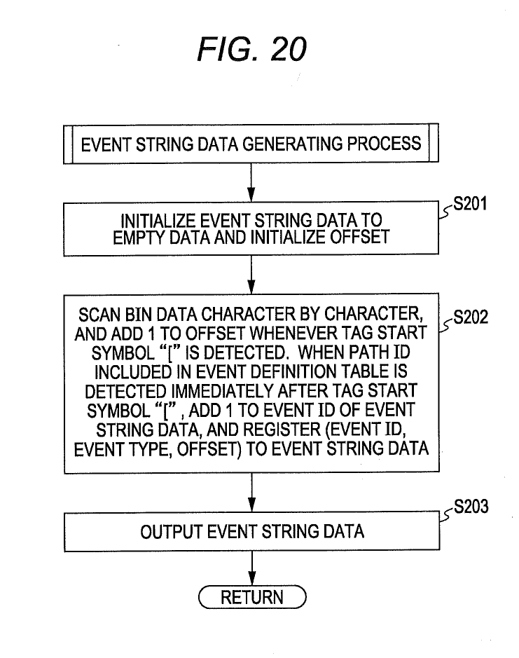

Next, the procedure of the event string data creating process shown in Step S103 of FIG. 19 will be described. In the event string data creating process, the event string creating unit 160c scans the BIN data 150c (see FIG. 9) and creates the event string data 150e (see FIG. 11). FIG. 20 is a flowchart illustrating the procedure of the event string data creating process.

As shown in FIG. 20, the event string creating unit 160c initializes the event string data 150e to a blank table, and initializes the offset (Step S201). Then, the event string creating unit 160c scans the BIN data 150c character by character, and adds 1 to the offset whenever detecting the tag start symbol “[”.

When the path ID included in the event definition table 150d is detected immediately after the tag start symbol “[”, the event string creating unit 160c adds 1 to the event ID of the event string data 150e, registers (event ID, event type, offset) to the event string data 150e (Step S202), and outputs the event string data 150e (Step S203).

In Step S202 of FIG. 20, the event type registered to the event string data 150e is specified by the comparison between the path ID detected immediately after the tag start symbol “[” and the event definition table 150d. For convenience of explanation, the offset of the event string data 150e shown in FIG. 11 is the node ID of a node corresponding to the path ID detected immediately after the tag start symbol “[”.

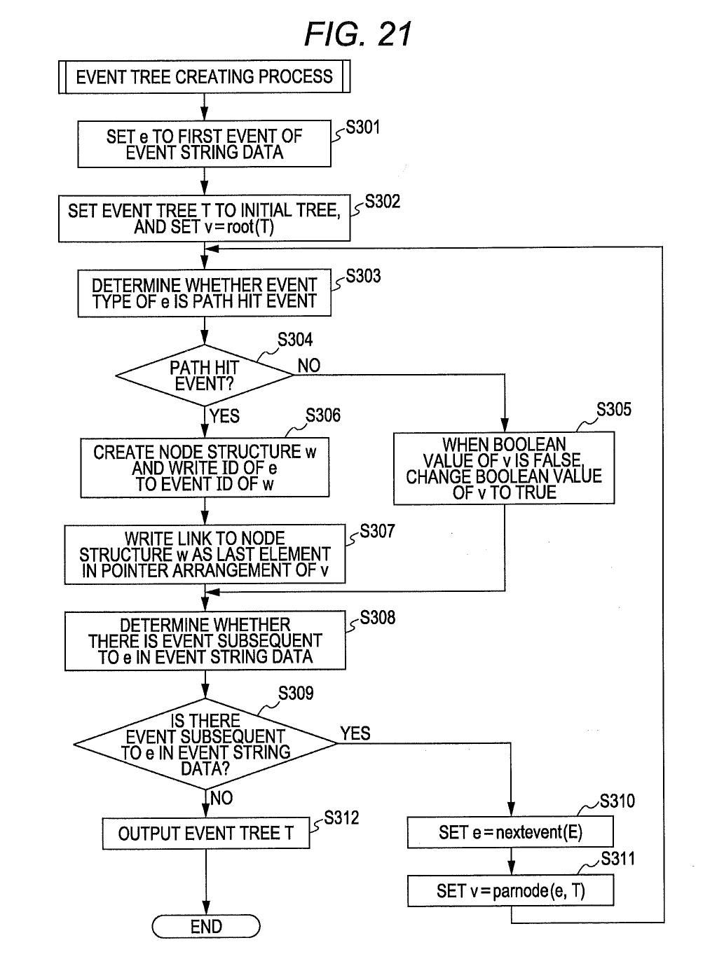

Next, the procedure of the event tree creating process shown in Step S104 of FIG. 19 will be described. In the event tree creating process, the event tree creating unit 160d scans the event string data 150e (see FIG. 11) and generates the event tree data 150f (see FIG. 13). FIG. 21 is a flowchart illustrating the procedure of the event tree creating process.

As shown in FIG. 21, the event tree creating unit 160d sets “e” to the first event of the event string data 150e (Step S301) and sets an event tree T as the initial tree, such that v=root(T) is satisfied (Step S302).

The event tree creating unit 160d determines whether the type of event e is a path hit event (Step S303). When it is determined that the type of event is not the path hit event (when the type of event is a predicate hit event) (Step S304, No) and the Boolean value (corresponding to the predicate of the node structure; see FIG. 12) of v is “false”, the event tree creating unit 160d changes the Boolean value of v to “true” (Step S305), and proceeds to Step S308.

On the other hand, when it is determined that the type of event is the path hit event (Step S304, Yes), the event tree creating unit 160d creates a node structure w, and writes the event ID of e to the event ID of w (Step S306). Then, the event tree creating unit 160d writes a link to the node structure was the last element in the pointer arrangement of v (Step S307).

The event tree creating unit 160d determines whether there is an event subsequent to the event e in the event string data 150e (Step S308). When it is determined that there is an event subsequent to the event e (Step S309, Yes), the following is set: e=nextevent(E) (Step S310) and v=parnode(e, T) (Step S311). Then, the event tree creating unit 160d proceeds to Step S303.

Here, e=nextevent(E) is a function that gives the next event of the current event. For example, in FIG. 11, when the current event has the event ID “1”, the event having the event ID “2” is specified by e=nextevent(E). In addition, v=parnode(e, T) is a function that specifies the parent node structure of the node structure designated by the current event e. For example, when the node structure 62 is designated by the current event e, the node structure 61 is given by v=parnode(e, T).

On the other hand, when it is determined that there is no event subsequent to the event e in the event string data 150e (Step S309, No), the event tree creating unit 160d outputs an event tree T (event tree data 150f) (Step S312).

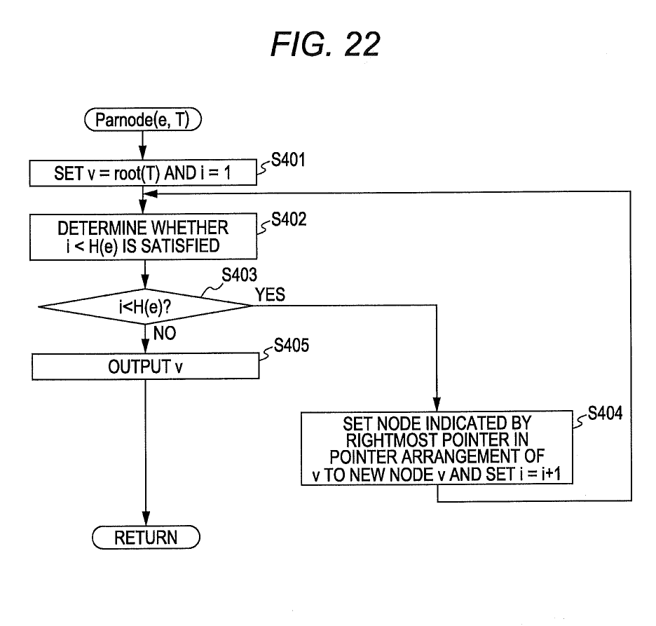

Next, a process corresponding to the function parnode(e, T) shown in Step S311 of FIG. 21 will be described. FIG. 22 is a flowchart illustrating the process corresponding to the function parnode(e, T). As shown in FIG. 22, when v=root (T) and i=1 (Step S401), the event tree creating unit 160d determines whether i<H(e) is satisfied (Step S402).

When the type of the event e is Zn or Pn, the height of e is defined as H(e)=n. For example, when the event e has the event ID “4”, the event type thereof is “Z3”. Therefore, the following is established: H(e)=3.

When i<H(e) is satisfied (Step S403, Yes), the event tree creating unit 160d sets the node indicated by the rightmost pointer in the pointer string of v to a new node v, and sets i=i+1 (Step S404). Then, the event tree creating unit 160d proceeds to Step S402. When i≧H(e) is satisfied (Step S403, No), the event tree creating unit 160d outputs v (Step S405).

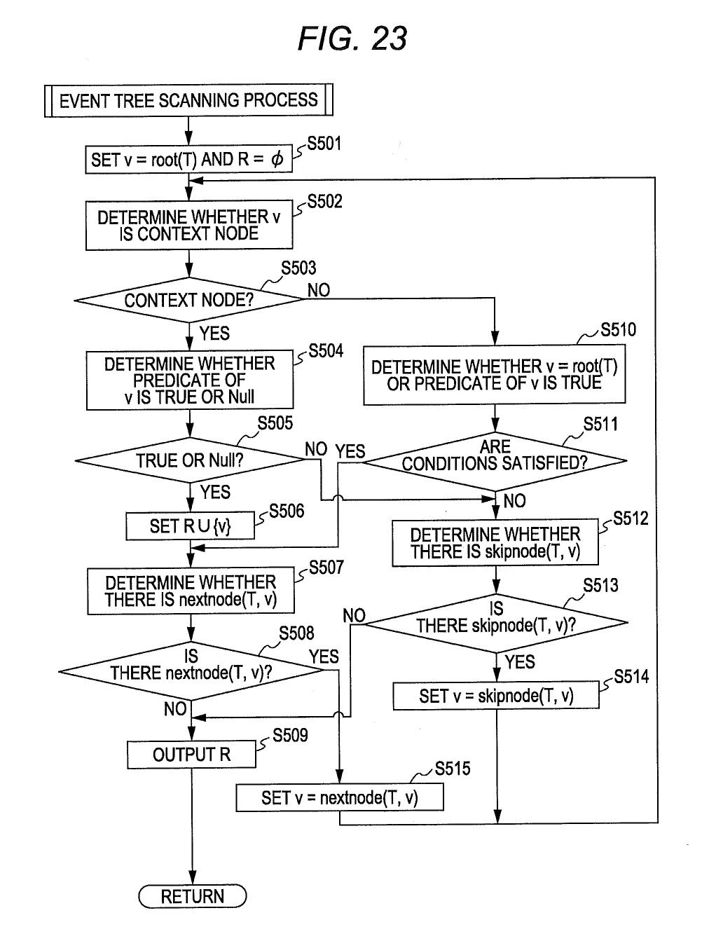

Next, the procedure of the event tree scanning process shown in Step S105 of FIG. 19 will be described. In the event tree scanning process, the event tree scanning unit 160e scans the event tree data 150f and determines the position designated by the query. FIG. 23 is a flowchart illustrating the procedure of the event tree scanning process.

As shown in FIG. 23, when v=root (T) and R=φ (empty set) (Step S501), the event tree scanning unit 160e determines whether v is the context node (Step S502). If it is determined that v is the context node (Step S503, Yes), the event tree scanning unit 160e determines whether the predicate of v is true or Null (Step S504).

When the predicate of v is true or Null (Step S505, Yes) and R∪{v} is satisfied (Step S506), the event tree scanning unit 160e determines whether there is nextnode(T, v) (Step S507). Here, nextnode(T, v) is a function that gives the next node of v in the preorder of the event tree data 150f.

For example, in FIG. 13, when the current node structure (node) is the node structure 60, the node structure 61 is given by nextnode(T, v). The definition of the tree structure in the preorder and a circulating method in the preorder are disclosed in, for example, the related art (Aho, Ullman, Hoperoft, “Information Processing Series 11, Data Structure and Algorithm”).

Returning to FIG. 23, if it is determined that there is no nextnode(T, v) (Step S508, No), the event tree scanning unit 160e outputs R (Step S509), and ends the event scanning process.

However, in Step S503, when v is not the context node (Step S503, No), the event tree scanning unit 160e determines whether v=root(T) or the predicate of v is true (Step S510). When the above conditions are satisfied (that is, when v=root(T) or the predicate of v is true) (Step S511, Yes), the event tree scanning unit 160e proceeds to Step S507.

On the other hand, when the above-mentioned conditions are not satisfied (that is, when v≠root(T) and the predicate is false) (Step S511, No), the event tree scanning unit 160e determines whether there is skipnode(T, v) (Step S512). Here, skipnode(T, v) is a function that defines the first node which is not included in a partial tree of v, among the nodes obtained by repeatedly applying nextnode(T, v) from v. For example, in FIG. 13, when the node structure 62 is designated by v, the node structure 63 is given by skipnode(T, v).

Returning to FIG. 23, if it is determined that there is no skipnode(T, v) (Step S513, No), the event tree scanning unit 160e proceeds to Step S509. On the other hand, if it is determined that there is skipnode(T, v) (Step S513, Yes) and v=skipnode (T, v) is satisfied (Step S514), the event tree scanning unit 160e proceeds to Step S502.

However, in Step S508, if it is determined that there is nextnode(T, v) (Step S508, Yes), the event tree scanning unit 160e sets v=nextnode(T, v) (Step S515), and proceeds to Step S502.

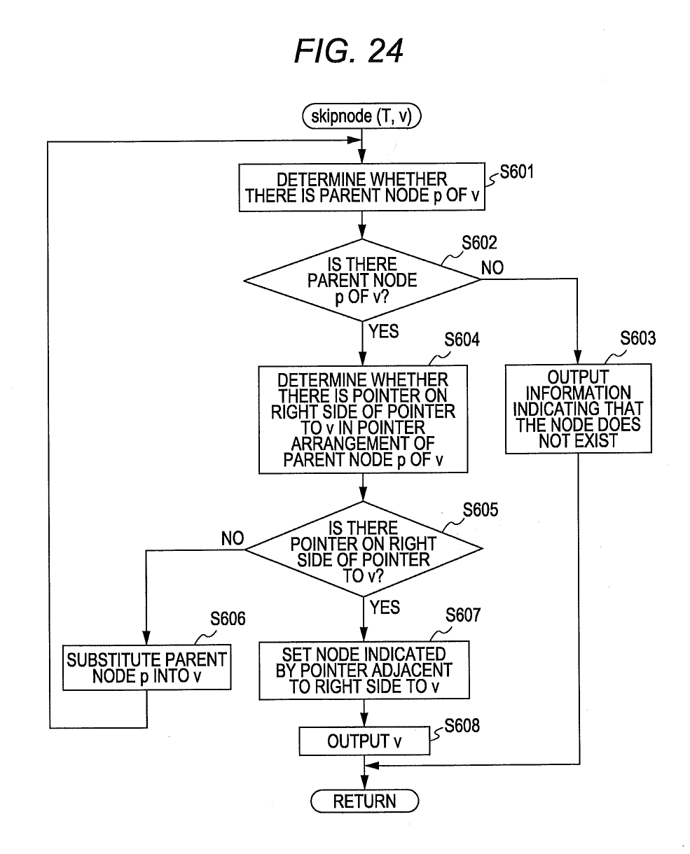

Next, a process corresponding to the function skipnode (T, v) shown in FIG. 23 will be described. FIG. 24 is a flowchart illustrating the process corresponding to the function skipnode(T, v). As shown in FIG. 24, the event tree scanning unit 160e determines whether there is a parent node p of v (Step S601). If it is determined that there is no parent node p of v (Step S602, No), the event tree scanning unit 160e outputs information indicating that “the node does not exist” (Step S603).

On the other hand, if it is determined that there is the parent node p of v (Step S602, Yes), the event tree scanning unit 160e determines whether there is a pointer on the right side of the pointer to v in the pointer arrangement of the parent node p of v (Step S604).

If it is determined that there is no pointer on the right side of the pointer to v (Step S605, No), the event tree scanning unit 160e substitutes the parent node p into v (Step S606), and proceeds to Step S601.

On the other hand, if it is determined that there is a pointer on the right side of the pointer to v (Step S605, Yes), the event tree scanning unit 160e sets the node indicated by the pointer adjacent to the right side as v (Step S607), and outputs v (Step S608).

As described above, in the search apparatus 100 according to this embodiment, the event tree creating unit 160d sets “true” indicating that the constraints of the query are satisfied or “false” indicating that the constraints of the query are not satisfied to the predicate (corresponding to a predicate node) of the node structure forming the event tree data 150f. Then, when scanning the event tree data 150f, the event tree scanning unit 160e refers to the predicate of the node structure. When the predicate is “true”, the event tree scanning unit 160e continuously performs scanning in a predetermined order and according to a predetermined rule to specify a context node, thereby detecting data. Therefore, it is possible to solve the problem of the same node structure (node) being scanned plural times even though the constraints of the query are satisfied as in the related art. As a result, it is possible to improve the efficiency of calculation.

In the search apparatus 100 according to this embodiment, the event tree scanning unit 160e refers to the predicate of the node structure. As a result of the reference, when the predicate is “false”, the event tree scanning unit 160e skips the scanning of a node structure connected under the node structure whose predicate is “false”. Therefore, it is possible to accurately designate the context node designated by the query, similar to the related art.

For example, as shown in FIG. 6, even when a plurality of nodes having the same label is included in the same brother, the search apparatus 100 according to this embodiment represents the predicate node with one bit of “true” or “false”. Therefore, it is possible to reduce the amount of data to be stored in a storage device. According to an aspect of an embodiment, a method/apparatus of searching a hierarchical structure document using a search formula, includes generating from the hierarchical structure document a structure of nodes including one or more predicate nodes indicating whether a condition of the search formula is satisfied; and searching the nodes while excluding a node indicating a prior predicate satisfied according to a predicate node, for data designated by the search formula. According to an aspect of an embodiment, the data of the hierarchical structure document is represented as an event tree data by associating a predicate hit event with a data path in the hierarchical structure document according to the search formula, and the one or more predicate nodes are generated according to the association of the predicate hit event and the path.

However, all or some of the processes according to this embodiment that are automatically executed may be manually executed. Alternatively, all or some of the processes that are manually executed in this embodiment may be automatically executed by a known method. In addition, information including the process procedures, the control procedures, specific names, and various types of data and parameters described in the specification and drawings may be arbitrarily changed except for specified cases.

The components of the search apparatus 100 shown in FIG. 7 are shown by functional concepts and are not necessarily physically constructed as shown in the drawings. That is, specific modes for dispersing and integrating the units are not limited to the illustrated ones, but all or some of the units may be functionally or physically dispersed or integrated in arbitrary units according to various types of loads and usage. Furthermore, all or some of the processing functions executed in the units may be implemented by a CPU and a program that is analyzed and executed by the CPU, or they may be implemented as hardware executed by a wired logic.

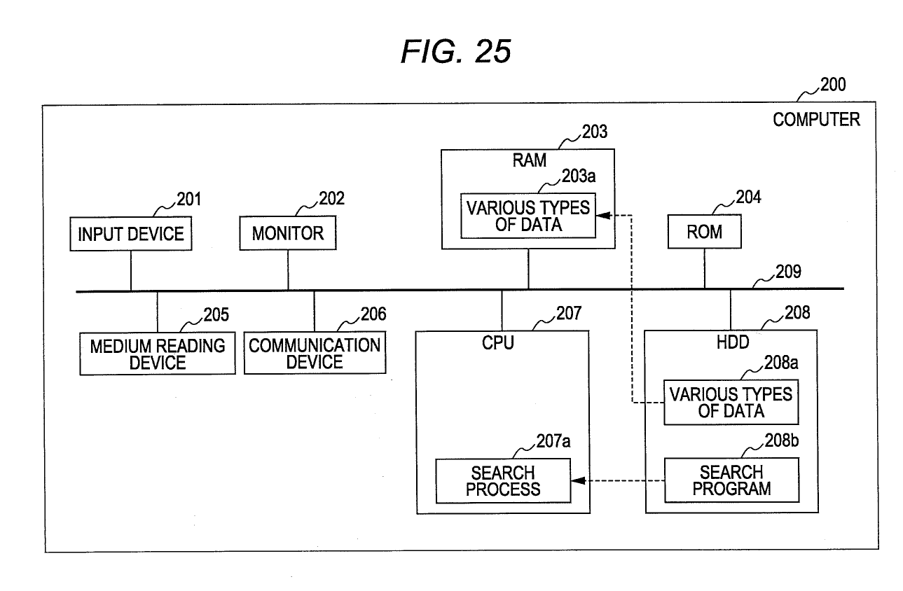

FIG. 25 is a diagram illustrating the hardware structure of a computer 200 forming the search apparatus 100 according to this embodiment. As shown in FIG. 25, the computer (search apparatus) 200 includes an input device 201, a monitor 202, a RAM (random access memory) 203, a ROM (read only memory) 204, a medium reading device 205 that reads data from a storage medium, a communication device 206 for data communication with other apparatuses (terminal apparatuses, for example), a CPU (central processing unit) 207, and an HDD (hard disk drive) 208 which are connected to each other by a bus 209.

The HDD 208 stores a search program 208b which exhibits the same function as that of the search apparatus 100. When the CPU 207 reads the search program 208b and executes the read search program, a search process 207a starts. The search process 207a corresponds to the BIN data generating unit 160a, the event definition table creating unit 160b, the event string creating unit 160c, the event tree creating unit 160d, and the event tree scanning unit 160e shown in FIG. 7.

The HDD 208 stores various types of data 208a corresponding to the data stored in the storage unit 150. The CPU 207 reads various types of data 208a stored in the HDD 208, stores the read data in the RAM 203, and uses various types of data 203a stored in the RAM 203 to crease query tree data and detect data corresponding to the position designated by the query.

The search program 208b shown in FIG. 25 is not necessarily stored in the HDD 208 at the beginning. The search program 208b may be stored, for example, in a “portable physical medium”, such as a flexible disk (FD), a CD-ROM, a DVD disk, a magneto-optical disk, or an IC card, that is inserted into the computer, a “fixed physical medium”, such as a hard disc drive (HDD) provided inside or outside the computer, or “another computer (or a server)” that is connected to the computer through, for example, a public network, the Internet, a LAN, or a WAN. Then, the computer may read and execute the search program 208b.

According to an aspect of the embodiments of the invention, any combinations of one or more of the described features, functions, operations, and/or benefits can be provided. The embodiments can be implemented as an apparatus (a machine) that includes computing hardware (i.e., computing apparatus), such as (in a non-limiting example) any computer that can store, retrieve, process and/or output data and/or communicate (network) with other computers. According to an aspect of an embodiment, the described features, functions, operations, and/or benefits can be implemented by and/or use computing hardware and/or software. In addition, an apparatus can include one or more apparatuses in computer network communication with each other or other apparatuses. In addition, a computer processor can include one or more computer processors in one or more apparatuses or any combinations of one or more computer processors and/or apparatuses. An aspect of an embodiment relates to causing one or more apparatuses and/or computer processors to execute the described operations. The results produced can be displayed on the display.

The program/software implementing the embodiments may also be included/encoded as a data signal and transmitted over transmission communication media. A data signal moves on transmission communication media, such as wired network or wireless network, for example, by being incorporated in a carrier wave. The data signal may also be transferred by a so-called baseband signal. A carrier wave can be transmitted in an electrical, magnetic or electromagnetic form, or an optical, acoustic or any other form.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A search method of allowing a computer to search a hierarchical structure document using a search formula, comprising:
creating a list in which a true flag indicating that conditions of a predicate of the search formula are satisfied or a false flag indicating that the conditions of the predicate of the search formula are not satisfied is set to a predicate node of the document data, based on the search formula; and
scanning the list according to the set predicate node to search for data designated by the search formula from the document data.

2. The search method according to claim 1,
wherein, in said searching of the data, when the list is scanned, it is determined whether the true flag or the false flag is set to the predicate node,
when the true flag is set to the predicate node, scanning is performed in a predetermined order and according to a predetermined rule, and
when the false flag is set to the predicate node, the scanning of a node connected under the predicate node to which the false flag is set is skipped, and a next element in the arrangement of nodes is scanned to search for data designated by the search formula from the document data.

3. A search apparatus for searching a hierarchical structure document using a search formula, comprising:
a true/false flag setting unit that, when the search formula of document data having the hierarchical structure of a plurality of nodes is acquired, creates a list in which a true flag indicating that conditions of a predicate of the search formula are satisfied or a false flag indicating that the conditions of the predicate of the search formula are not satisfied is set to a predicate node of the document data, based on the search formula; and
a search unit that scans the list according to the set predicate node to search for data designated by the search formula from the document data.

4. The search apparatus according to claim 3,
wherein, when the list is scanned, the search unit determines whether the true flag or the false flag is set to the predicate node,
when the true flag is set to the predicate node, the search unit performs scanning in a predetermined order and according to a predetermined rule, and
when the false flag is set to the predicate node, the search unit skips the scanning of a node connected under the predicate node to which the false flag is set, and scans a next element in the arrangement of nodes to search for data designated by the search formula from the document data.

5. A storage medium having a search program recorded therein which allows a computer to search a hierarchical structure document using a search formula, the search program causing the computer to execute:
creating a list in which a true flag indicating that conditions of a predicate of the search formula are satisfied or a false flag indicating that the conditions of the predicate of the search formula are not satisfied is set to a predicate node of the document data, based on the search formula; and
scanning the list according, to the set predicate node to search for data designated by the search formula from the document data.

6. The storage medium according to claim 5,
wherein, in said searching of the data, when the list is scanned, it is determined whether the true flag or the false flag is set to the predicate node,
when the true flag is set to the predicate node, scanning is performed in a predetermined order and according to a predetermined rule, and
when the false flag is set to the predicate node, the scanning of a node connected under the predicate node to which the false flag is set is skipped, and a next element in the arrangement of nodes is scanned to search for data designated by the search formula from the document data.

7. A method of searching a hierarchical structure document using a search formula, comprising:
generating from the hierarchical structure document a structure of nodes including one or more predicate nodes indicating whether a condition of the search formula is satisfied; and
searching the nodes while excluding a node indicating a prior predicate satisfied according to a predicate node, for data designated by the search formula.

8. The method according to claim 7, further comprising associating a predicate hit event with a path according to the search formula,
wherein the one or more predicate nodes are generated according to the association of the predicate hit event and the path.
